(19) United States
(12) Patent Application Publication
(10) Pub. No.: US 2021/0233258 A1
(43) Pub. Date: Jul. 29, 2021

(54) IDENTIFYING SCENE CORRESPONDENCES WITH NEURAL NETWORKS

(71) Applicant: Embodied Intelligence Inc., Berkeley, CA (US)

(72) Inventors: Maximilian Sieb, Berkeley, CA (US); Nikhil Mishra, Berkeley, CA (US); Rocky Duan, Berkeley, CA (US)

(21) Appl. No.: 17/161,399

(22) Filed: Jan. 28, 2021

Related U.S. Application Data
(60) Provisional application No. 62/966,811, filed on Jan. 28, 2020.

(51) Int. Cl. G06T 7/246; G06K 9/62; G06K 9/00; B25J 9/16; G06N 3/08; G06N 3/04

(52) U.S. Cl. CPC G06T 7/248; G06K 9/6201; G06K 9/00624; B25J 9/1697; G06T 2207/20084; G06N 3/04; G06K 2209/21; G06K 2209/19; G06N 3/08

(57) ABSTRACT

Various embodiments of the present technology generally relate to robotic devices, computer vision, and artificial intelligence. More specifically, some embodiments relate to object tracking using neural networks and computer vision systems. In some embodiments, a computer vision system for object tracking captures one or more images of a first scene, wherein the first scene corresponds to a first location, identifies a distinct object in the first scene based on the one or more first images, directs a robotic device to move the distinct object from the first location to a second location, captures one or more second images of a second scene, wherein the second scene corresponds to the second location, and determines if the distinct objects is in the second scene based on the one or more second images.

### CROSS-REFERENCE TO RELATED APPLICATIONS

This application is related to and claims priority to U.S. Provisional patent Application No. 62/966,811, entitled “IDENTIFYING SCENE CORRESPONDENCES WITH NEURAL NETWORKS,” filed on Jan. 28, 2020, which is incorporated by reference herein in its entirety.

### BACKGROUND

Many tasks require the ability of a machine to sense or perceive its environment and apply knowledge about its environment to future decisions. Machines programmed solely to repeat a task or action, encounter issues or frequently get stuck, often requiring human intervention too frequently to increase productivity or efficiency. Robotic devices and other machines are often guided with some degree of computer vision.

Computer vision techniques enable a system to gain insight into its environment based on digital images, videos, scans, and similar visual mechanisms. High-level vision systems are necessary for a machine to accurately acquire, process, and analyze data from the real world. Computer vision and machine learning methods allow a machine to receive input and generate output based on the input. Some machine learning techniques utilize deep artificial neural networks having one or more hidden layers for performing a series of calculations leading to the output. In many present-day applications, convolutional neural networks are used for processing images as input and generating a form of output or making decisions based on the output.

Artificial neural networks, modeled loosely after the human brain, learn mapping functions from inputs to outputs and are designed to recognize patterns. A deep neural network comprises an input layer and an output layer, with one or more hidden layers in between. The layers are made up of nodes, in which computations take place. Various training methods are used to train an artificial neural network during which the neural network uses optimization to continually update weights at the various nodes based on failures until a satisfactory model is achieved. Many types of deep neural networks currently exist and are used for a broad variety of applications and industries including computer vision, series forecasting, automated driving, performing medical procedures, aerospace, and many more. One advantage of deep artificial neural networks is their ability to learn by example, rather than needing to be specifically programmed to perform a task, especially when the tasks would require an impossible amount of programming to perform the operations they are used for today.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to robotic devices, artificial intelligence, and computer vision. More specifically, some embodiments relate to a method of corresponding objects across scenes for robotic picking, wherein the method comprises capturing one or more first images of a first scene, wherein the first scene corresponds to a first location and identifying a distinct object in the first scene based on the one or more first images. The method further comprises capturing one or more second images of a second scene, wherein the second scene corresponds to a second location and determining if the distinct object is in the second scene based on the one or more second images of the second scene.

In some embodiments, the described method further comprises, if the distinct object is in the second scene, identifying a correspondence between the one or more first images and the one or more second images. Further, the method may comprise, if the distinct object is not in the second scene, identifying a non-match between the one or more first images and the one or more second images. Even further, the method of claim 1, may further comprise capturing one or more second images of the first scene and determining if the distinct object is still in the first scene based on the one or more second images of the first scene. In some embodiments, the method comprises directing a robotic device to move the distinct object from the first location to the second location, wherein the first location is inside of a bin comprising a plurality of distinct objects and the second location is inside of a second bin. The robotic device, in some examples, comprises at least one picking element and wherein the method further comprises attempting to pick up the distinct object using the at least one picking element.

In an alternative embodiment, a system comprises one or more computer-readable storage media, a processing system operatively coupled to the one or more computer-readable storage media, and program instructions, stored on the one or more computer-readable storage media. The program instructions, when read and executed by the processing system, direct the processing system to capture one or more first images of a first scene, wherein the first scene corresponds to a first location, identify a distinct object in the first scene based on the one or more first images, capture one or more second images of a second scene, wherein the second scene corresponds to a second location, and determine if the distinct object is in the second scene based on the one or more second images of the second scene.

In yet another embodiment, one or more computer-readable storage media has program instructions stored thereon for identifying scene correspondences. The program instructions, when read and executed by a processing system, direct the processing system to at least capture one or more first images of a first scene, wherein the first scene corresponds to a first location, identify a distinct object in the first scene based on the one or more first images, capture one or more second images of a second scene, wherein the second scene corresponds to a second location, and determine if the distinct object is in the second scene based on the one or more second images of the second scene.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computer vision and robotic picking environment in accordance with some embodiments of the present technology.

FIG. 2 illustrates a computer vision and robotic picking environment in accordance with some embodiments of the present technology.

FIG. 3 is a flow chart with a series of steps for corresponding object instances in accordance with some embodiments of the present technology.

FIG. 4 is a flow chart with a series of steps for corresponding object instances in accordance with some embodiments of the present technology.

FIG. 5 illustrates an example of object instance correspondence in accordance with some embodiments of the present technology.

FIG. 6 illustrates an example of object instance correspondence in accordance with some embodiments of the present technology.

FIG. 7 illustrates an example of object instance correspondence in accordance with some embodiments of the present technology.

FIG. 8 is a flow chart with a series of steps for corresponding object instances in accordance with some embodiments of the present technology.

FIG. 9 is an example of a computing system in which some embodiments of the present technology may be utilized.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Various embodiments of the technology described herein generally relate to systems and methods for object instance correspondence. More specifically, certain embodiments relate to neural network models for matching corresponding instances and detecting non-matches. In some embodiments, a robotic device may work in collaboration with a computer vision system for collecting visual data. Based on the visual data, machine learning techniques are implemented for detecting corresponding object instances between two or more scenes. In some examples, the machine learning techniques utilize one or more different types of artificial neural networks for determining if an item was successfully picked by a robotic device, successfully relocated by a robotic device, tracking the location of an instance, and similar tracking related matters.

Artificial neural networks, such as those that may be implemented within embodiments related to computer vision, robotic picking, segmentation, depth perception, and similar models described herein, are used to learn mapping functions from inputs to outputs. Generating mapping functions is done through neural network training processes. Many various types of training and machine learning methods presently exist and are commonly used including supervised learning, unsupervised learning, reinforcement learning, imitation learning, and many more. During training, the weights in a neural network are continually updated in response to errors, failures, or mistakes. In order to create a robust, working model, training data is used to initially dial in the weights until a sufficiently strong model is found or the learning process gets stuck and is forced to stop. In some implementations, the weights may continue to update throughout use, even after the training period is over, while in other implementations, they may not be allowed to update after the training period.

Parameters of a neural network are found using optimization with many, or sometimes infinite, possible solutions. Modern deep learning models, especially for computer vision and image processing, are based on convolutional neural networks, although they may also incorporate other deep generative models. As described herein, artificial neural networks for object instance tracking, computer vision, robotic picking, and other processes described herein first require training. A variety of different training methods may be used to train a neural network for instance tracking, segmenting units, or picking and placing items in a bin in accordance with embodiments of the technology described herein.

Object instance correspondence is useful to and can be applied to a wide variety of scenarios. In the present disclosure, many examples will be provided in the field of robotic picking in warehouse or industrial environments. However, object correspondence using artificial neural networks and computer vision may be applicable to a wide variety of tasks, processes, and applications and should not be limited to the specific uses or environments discussed herein.

Systems and methods discussed herein use deep neural networks (DNNs) to correspond and track object instances in scenes in which a robotic device may be picking or attempting to pick items. Object correspondence may include detecting new objects, detecting missing objects, detecting corresponding objects in different scenes or in the same scene, detecting double picks, detecting drops, target placement, multi-step tracking, database and object correspondence, and similar tracking or correspondence-related functions. The tracking system discussed herein advantageously provides the ability to detect new objects in a scene, indicate whether previously detected objects have moved, and identify a location that they have moved to. In some examples, a computer vision system may capture two images of the same general area, where one image is captured first and the second is captured after something has been changed, or after something is supposed to have changed. The tracking system may determine what changed and what did not change between the images.

Several applications have been contemplated as falling within the scope of the present disclosure and are provided herein for purposes of example and explanation. However, additional applications exist and are anticipated. A first application contemplated within the scope of the present technology is the use of the tracking system provided herein for keeping track of how many times a specific object has failed to be picked up by a robotic picking device. Keeping track of picking failures for a specific object may provide a means for determining when and if to stop attempting to pick up an item with the robotic picking device. In some embodiments, an object may be flagged if it has had too many failed attempts and left for human intervention or the like. Similarly, tracking picking failures for an object may help indicate that that the robotic picking device should adjust its picking strategy before attempting to pick up the item again.

In another application that falls within the scope of the present technology, the tracking system may be used for detecting double picks in the context of a robotic picking environment. In most scenarios, although not all scenarios, a robotic picking device should only pick up one item at a time. For example, when fulfilling a shipment request, a robotic picking device may be used for picking an ordered item and placing it into a box or onto a conveyor belt for shipment. Thus, if a single pick yields more than a single object on accident, it can incorrectly fulfil or corrupt an order. The present technology may be used to detect that more than one item is missing from a starting bin, that two items are actively being picked by a robotic device, or that more than one object has been moved to a new location.

In a third application, the tracking model discussed herein may be used to scan a database of images and localize specific object appearances in each image. This may be useful for purposes of research and/or identifying scenes comprising objects that may be difficult to pick or detect. Traditionally, this task may be performed by a human operator or by another system before being passed over to a warehouse environment or tracking model. However, streamlining this process using a tracking model in the context of robotic picking may provide an advantage in understanding which items may be difficult to pick or detect, or items that should not be attempted because of a high risk of failure. In some examples, this may be implemented during the training of a neural network for the tracking system discussed herein.

In yet another application, the tracking model discussed herein may be used for multi-step tracking, such as on a conveyor belt. Generally, continuous tracking over a long period of time can be a difficult problem. However, in some environments, the present model may provide a means for tracking objects across multiple steps of a process such as in various locations along a process. Additional applications may include target placement correspondence and repicking of dropped items. Knowledge regarding dropped items may be useful in a warehouse environment in that it could prevent the need for frequent human intervention. If a robotic picking device drops an item but has the ability to recognize that the item was dropped and then determine if the item is in a location where it can be repicked, the system may avoid downtime or other problems.

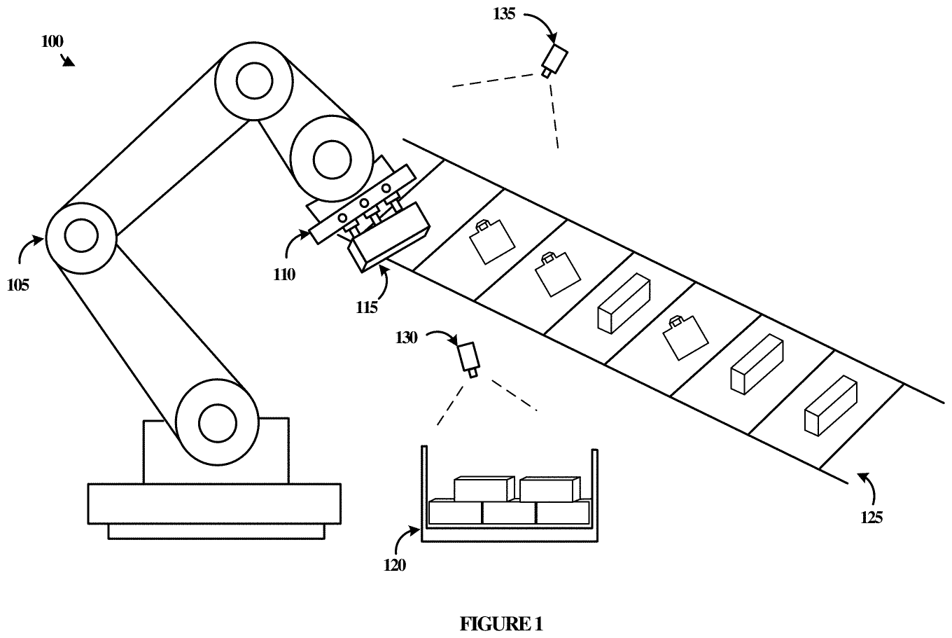

FIG. 1 illustrates an example of warehouse environment 100 having robotic arm 105 for picking items from a bin in accordance with some embodiments of the present technology. FIG. 1 includes robotic arm 105, bin 120, conveyor belt 125, camera 130, and camera 135. Robotic arm 105 comprises picking element 110. Picking element 110 comprises a set of suction-based picking mechanisms, however different numbers and types of picking mechanisms may be utilized in accordance with the present embodiment. Bin 120 is holding boxes that may be found in a warehouse, commercial setting, or industrial setting. Many other types of items may be in a bin or similar container for picking in accordance with the present embodiment. In the present example, robotic arm 105 is a six-degree-of-freedom (6DOF) robotic arm. Picking element 110 is designed for picking items out of bin 120 and placing them onto compartments of conveyor belt 125.

An autonomous robot may benefit from having a means for recognizing the environment around it and processing that information to come up with a way to perform a task. Thus, if a robot is picking items out of a bin, it should be able to sense the location and position of a specific item and apply that to determine how to pick up the item and move it to a desired location. A robot capable of sensing and applying that knowledge, even within highly repetitive settings, dramatically decreases the need for human intervention, manipulation, and assistance. Thus, human presence may no longer be required when items are not perfectly stacked or when a robot gets stuck, as a few examples. If a robot regularly gets stuck, it may defeat the purpose of having a robot altogether, because humans may be required to frequently assist the robot.

In some examples, robotic arm 105 and picking element 110 may pick boxes from bin 120 one at a time according to orders received and place the items on the conveyor belt for packaging or place them into packages for shipment. Furthermore, robotic arm 105 and picking element 110 may be responsible for picking items from various locations in addition to bin 120. For example, several bins comprising different merchandise may be located in proximity to robotic arm 105, and robotic arm 105 may fulfill requests for the different pieces of merchandise by picking the correct type of merchandise and placing it onto conveyor belt 125.

Picking element 110 may comprise one or more picking mechanisms for grabbing items in a bin. Picking mechanisms may include one or more suction mechanisms, gripping mechanisms, robotic hands, pinching mechanisms, magnets, or any other picking mechanisms that could be used in accordance with the present disclosure. In some examples, picking element 110 may be additionally used for perturbation, such as poking, touching, stirring, or otherwise moving any items in bin 120, as just a few examples. In further examples, robotic arm 105 may comprise a perturbation element such as a pneumatic air valve connected to a pneumatic air supply, wherein the pneumatic air valve releases compressed air into bins in certain situations. A perturbation sequence may be used in situations where a DNN or another model determines that there is low probability that it will be able to pick up any items in bin 120 as they are presently arranged. In some examples, the robotic arm may have already tried and failed to pick every visible item in the bin, and therefore decides to initiate a perturbation sequence. Robotic arm 105 may move and position picking element 110 such that it is able to pick up an item in bin 120. In certain embodiments, determining which item to pick up and how to pick it up is determined using at least one deep artificial neural network. The deep neural network (DNN) may be trained to guide item pick-up and determine which items have the greatest probabilities of pick-up success. In other embodiments, picking may be guided by a program that does not use a DNN for decision making.

A computer vision system in accordance with embodiments herein may comprise any number of visual instruments, such as cameras or scanners, in order to guide motion, picking, and object correspondence. A computer vision system may receive visual information and provide it to a computing system for analysis. Based on the visual information provided by the computer vision system, the system can guide motions and actions taken by robotic arm 105. A computer vision system may provide information that can be used to decipher geometries, material properties, distinct items (segmentation), bin boundaries, and other visual information related to picking items from a bin. Based on this information, the system may decide which item to attempt to pick up and can then use the computer vision system to guide robotic arm 105 to the item. A computer vision system may also be used to determine that items in the bin should be perturbed in order to provide a higher probability of picking success. A computer vision system may be in a variety of locations allowing it to properly view bin 120 from, either coupled to or separate from robotic arm 105. In some examples, a computer vision system may be mounted to a component of robotic arm 105 from which it can view bin 120 or may be separate from the robotic device.

Camera 130 images the contents of bin 120 and camera 135 images a region of conveyor belt 125. Each of camera 130 and camera 135 may comprise one or more cameras. In some examples, a camera in accordance with the present example such as camera 130 comprises an array of cameras for imaging a scene such as in bin 120. Camera 130 and camera 135 are part of a computer vision system associated with robotic arm 105 such as a computer vision system in accordance with the technology disclosed herein.

In the example of FIG. 1, robotic arm 105 has successfully picked box 115 from bin 120 and is in the process of moving box 115 to conveyor belt 125. The computer vision system including camera 130 may have helped guide robotic arm 105 when picking box 115. In some examples, before picking box 115, the computer vision system imaged the contents of bin 120, performed a segmentation sequence using the images, and identified box 115 for picking based on the segmentation results. Segmentation plays an important role in a warehouse environment and robotic picking such as in the example of FIG. 1. However, segmentation may be performed in a variety of manners in accordance with the present technology and used as input for tracking models described herein.

In the context of warehouse environment 100, the tracking model disclosed herein may be utilized in a variety of manners. In one example, camera 130 is used to capture a first image of the contents of bin 120. Robotic arm 105 may then attempt to pick an item from bin 120, such as box 115. After attempting to pick box 115, camera 130 may capture a second image of the contents of bin 120 to determine if box 115 was successfully picked. The computer vision system may use object correspondence to determine that box 115 is still in the same spot and robotic arm 105 failed to pick it up, that box 115 is still in the bin but in a different position and robotic arm 105 therefore failed to pick it up, or recognize that there is a no-match for box 115 in bin 120 and that robotic arm 105 therefore successfully picked up box 115.

In other examples, or in addition to the previous example, camera 135 may be used to track box 115 based on the first image taken by camera 130. Camera 135 may recognize that robotic arm 105 has picked up and is currently holding box 115 or may recognize that box 115 has been successfully placed onto conveyor belt 125 by robotic arm 105. In another scenario, camera 135 may recognize that box 115 is neither in the possession of robotic arm 105 nor was it placed on conveyor belt 125 and box 115 may have therefore been dropped.

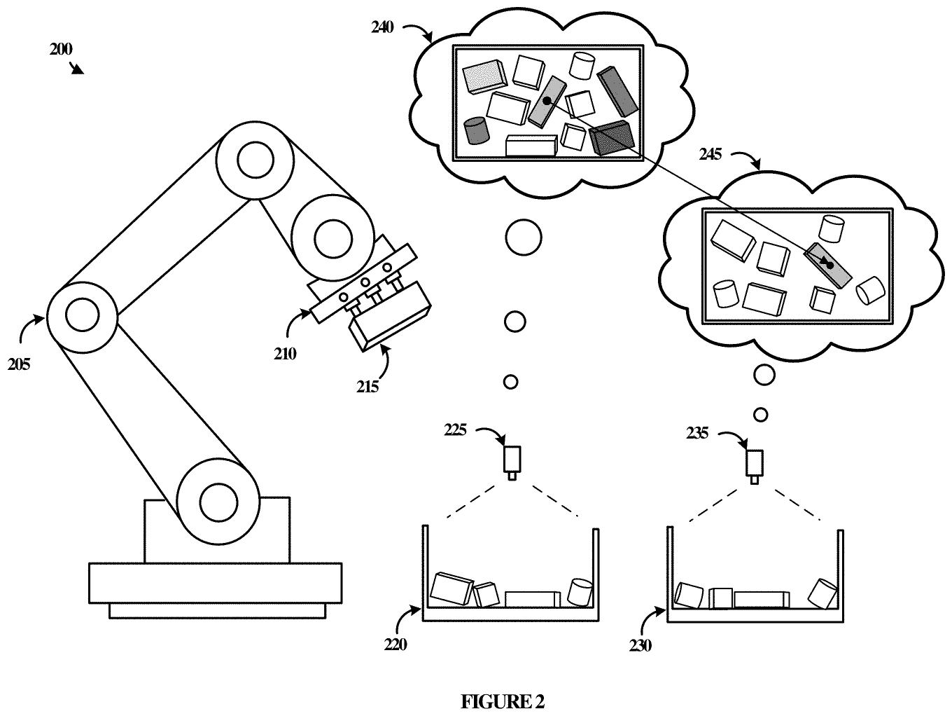

FIG. 2 illustrates picking and tracking environment 200 in accordance with some embodiments of the present technology. Picking and tracking environment 200 includes robotic arm 205, picking device 210, box 215, bin 220, camera 225, bin 230, camera 235, camera view 240 corresponding to camera 225 and bin 220, and camera view 245 corresponding to camera 235 and bin 230. In the present example, robotic arm 205 is attempting to move box 215 from bin 220 to bin 230. Each of cameras 225 and 235 may represent a single camera or may represent an array of cameras used to capture one or more images of their associated bins. Camera 225 has taken a first image of bin 220, which is shown in camera view 240. Camera view 240 is showing an image of the contents of bin 220 prior to a successful pick by robotic arm 205. Likewise, camera view 245 is showing an image of the contents of bin 230 after robotic arm 205 has successfully placed box 215 in bin 230. The arrow drawn from the instance of box 215 in camera view 240 to the instance of box 215 in camera view 245 illustrates the identified object correspondence between the images.

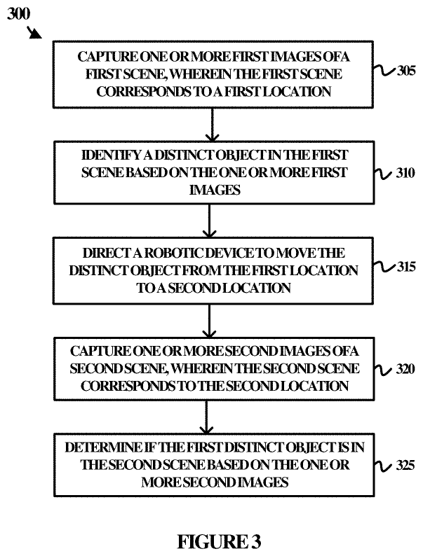

FIG. 3 is a flow chart illustrating process 300 comprising a series of steps for operating a computer vision system for object tracking. In step 305, the computer vision system captures one or more first images of a first scene, wherein the first scene corresponds to a first location. In some examples, the first scene may be the contents of a bin, and the first location may be the bin, such as in the example of FIG. 2. In many examples described herein, an image may be a collection of images taken by multiple cameras of the same general areas. The collection of images may be used individually or combined to generate a single image for use in object correspondence.

In step 310, the computer vision system identifies at least one distinct object in the first scene based on the one or more first images. The computer vision system may identify more than one distinct object in accordance with the present example and in some examples, may identify a plurality of distinct objects in the first scene. The tracking model described herein does not perform image segmentation but may receive a segmented image from a different model, based on which the model herein may identify the distinct objects of the segmented image. In step 315, the computer vision system may, at least in part, direct or assist a robotic device to move the distinct object from the first location to a second location. For example, the computer vision system of FIG. 2 may assist robotic arm 205 to move an item from bin 220 to bin 230, as directed by one or more systems for operating robotic arm 205. The computer vision system may help in guiding robotic arm 205 when picking up and moving the distinct object to bin 230.

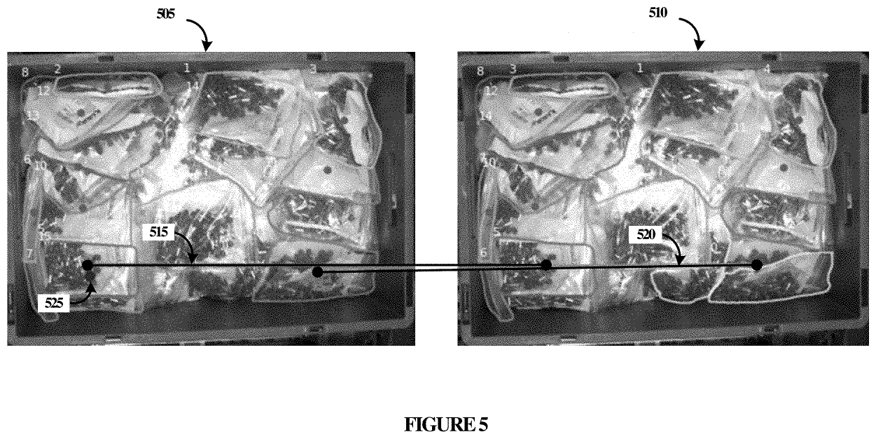

In step 320, the computer vision system captures one or more second images of a second scene, wherein the second scene corresponds to the second location. Continuing the example from above, the computer vision system may image the contents of bin 230 in step 320. Upon imaging the contents of bin 230, a segmentation model may perform segmentation for the one or more images collected of bin 230 before returning the output of the segmentation model to the tracking model discussed herein. In step 325, the tracking model determines if the first distinct object is in the second scene based on the one or more second images. Identifying corresponding objects between scenes is discussed in further detail with reference to FIGS. 5, 6, and 7.

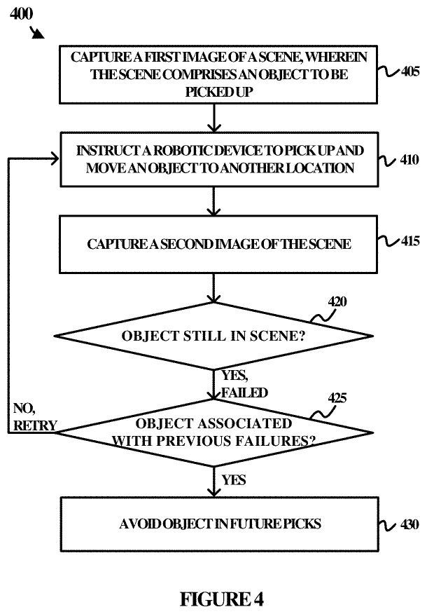

FIG. 4 is a flow chart illustrating process 400 comprising a series of steps for operating an object tracking system in accordance with some embodiments of the present technology. In step 405 of process 400, the tracking system captures a first image of a scene, wherein the scene comprises an object to be picked up. In step 410, the tracking system instructs a robotic device to pick up and move an object to another location. Next, in step 415, the tracking system captures a second image of the scene. Contrary to the previous example, the second image is taken by the same camera or camera system as the first image. The second image is taken of the same scene as the first image. The process of FIG. 4 is relevant for detecting missing items, detecting failed picks, or any other application in which it may be useful to image the same scene to determine correspondences.

In step 420, the object tracking system determines if the object is still in the scene. If the object is still in the scene, the robotic device has failed to pick up the object. In some examples, the object may still be in the same position as during the first image capture, while in other examples, the object may still be in the scene, but in a different location or position, indicating a disruption by the robotic device but without successful pickup. If the object is not still in the scene, the tracking system may continue to a variety of steps not shown here for purposes not shown here for purposes of brevity, but including using a different camera or computer vision system to identify the object in a different location or to verify successful placement in another location. If the object is still in the scene, process 400 continues to step 425, in which the tacking system determines if the object is associated with previous picking failures.

Many different settings or rules may be associated with step 425 including a maximum number of failures or the like. In the present example, the tracking system and robotic device should only attempt to pick the object twice before determining to avoid the object or change the picking strategy. Thus, if the object has been failed to pick once before, the process continues to step 430, in which the system flags the object for avoidance in future picks. In some examples, the object may be left for human intervention. In other examples, instead of avoiding the object in future picks, the system may determine an alternative picking strategy for the object and attempt the new picking strategy. If the object is not yet associated with any failed picks, process 400 may return to step 405 or 410, depending on the embodiment, to retry picking the object or recapture a new image of the object.

FIG. 5 shows two adjacent images, image 505 and image 510, each taken of the same tote at different times. Image 505 and image 510 show an example of a challenging tracking instance because the items in the bin look nearly identical and consist of clear, challenging-to-decipher, materials. Image 505 shows a tote with items in it before a robot's attempted pick. Image 510 shows the same tote with items in it after the robot's successful pick. Items in each bin of FIG. 5 are outlined with boundaries drawn around them. The outlines drawn around the objects in the present example are the result of a segmentation process performed by another model and therefore is not discussed in detail here. However, the tracking model discussed herein operates based on the boundaries provided by the segmentation model. Given a query image, image 505 in the present example, the tracking model predicts which object instance in the target image, image 510, corresponds to each object instance in the query image.

A green dot within an object boundary in image 505 and image 510 means that the tracking model has identified an object correspondence because the item did not move by a large amount. The green dot indicates that the tracking model predicts the object to have stayed in place. A line drawn between two dots shows that the object center has moved by some amount and it shows where it predicts the new object center to be. Furthermore, a blue dot indicates that the tracking model predicted that the object has disappeared.

Each item in image 505 with a corresponding item that is determined to have stayed in relatively the same location in image 510 is marked with a green dot. Line 515 connects a set of corresponding dots between image 505 and image 510, indicating that the tracking model believes the object corresponding to each line has changed the location of its object center. Line 520 connects a set of corresponding dots between image 505 and image 510 for the same reason. Blue dot 525 indicates a spot where it predicts an object used to be but is not present in image 510. In the present example, the tracking model has associated all item pairs correctly based on the output of a segmentation model. It is worth nothing that the output of the segmentation model is not identical between image 505 and image 510, but the tracking model has performed correctly based on the segmentation output.

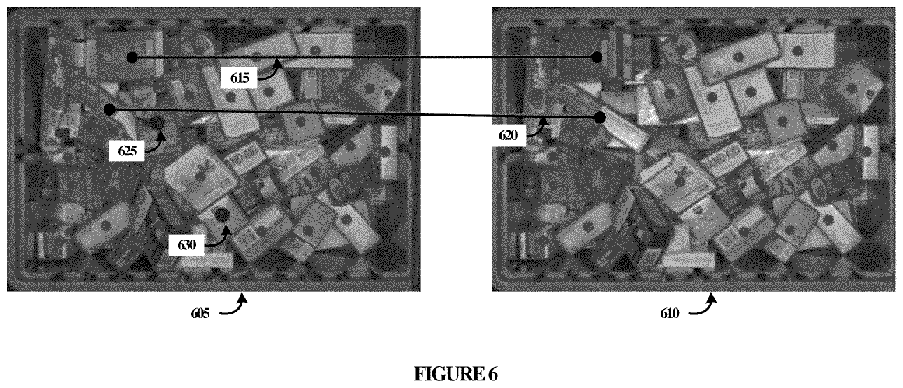

FIG. 6 shows another example of object tracking, similar to FIG. 5, but with a change in contents between two images. FIG. 6 includes image 605 and image 610, wherein each image is of a bin comprising several types of boxes. As in the previous example, a green dot indicates that the tracking model has found corresponding objects and predicted that they are in the same place. A blue dot indicates that the item in image 605 is no longer in the bin in image 610. Blue dot 625 indicates an orange box that was present when image 605 was taken but is missing from image 610. Line 615 connects dots identifying a green box in both images, but indicates that the green box has changed position, likely due to the removal of the orange box corresponding to blue dot 625. Line 620 connects two dots identifying a box that has been decluttered and the segmentation results have therefore differed. The tracking model of the present example has correctly predicted the associations between image 605 and image 610.

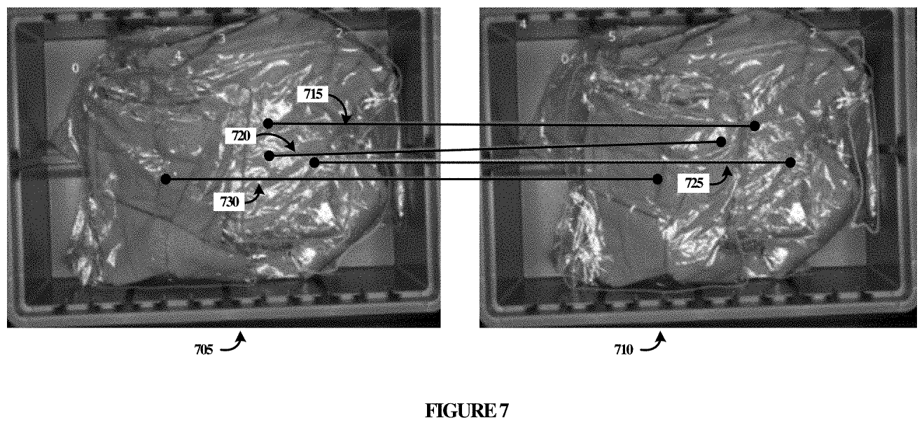

FIG. 7 illustrates yet another example of a challenging tracking scenario in which the tracking system disclosed herein correctly identifies correspondences between image 705 and 710 based on the segmentation model outputs. Image 705 represents a first image taken and image 710 represents a second image taken. The tracking model of the present disclosure correctly identifies the correspondence between the object instances of image 705 and image 710. Line 715, line 720, line 725, and line 730 indicate that the centers of object instances associated with the connected dots have moved.

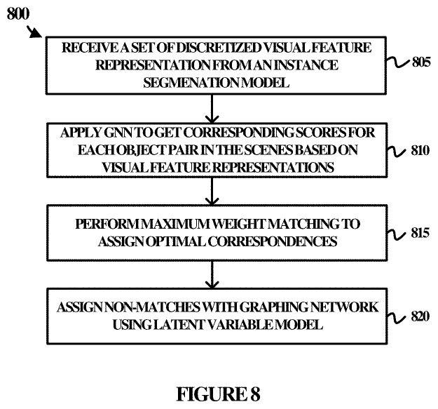

FIG. 8 is a flow chart showing tracking process 800 featuring steps performed by a neural net architecture in accordance with the present disclosure. The neural net architecture implemented within an object tracking system described herein provides fundamental building blocks by implementing deep learning. The system herein advantageously may use a graph neural network (GNN) architecture in addition to a unique output matching process to perform object tracking in a variety of scenarios including but not limited to the previous examples provided herein. In step 805 of tracking process 800, a tracking model receives a set of discretized visual feature representations from an instance segmentation model. As previously discussed, the segmentation results are provided by another model that is external to the tracking model used in the present example. However, the output of the segmentation model plays an important role in tracking process 800 because it provides a starting point for finding object correspondences based on segmentation results. The tracking model discussed here may utilize pre-computed object-centric object masks produced by a segmentation model to facilitate object tracking. In some examples, the object masks enable the composition feature representations of each object using convolutional features extracted by a segmentation model from the raw RGB input, wherein the feature representations are ROI-aligned using previously computed object masks and bounding box geometries in some implementations.

In step 810, the tracking model applies a GNN to obtain corresponding scores for each object pair in the scene based on visual feature representations. In some examples, the scores are pairwise scores determined for all possible object correspondences, including a dummy feature, which will be explained in further detail in the next paragraph. The visual feature representations may be included in the provided segmentation results but nonetheless play an important role in tracking process 800. The corresponding scores may then be used to perform maximum weight matching to assign optimal correspondences in step 815. The maximum weight matching identifies the most likely matches across all computed scores.

The maximum weight matching algorithm is also extended such that a dummy feature can be matched to as many objects as needed in the source image. The dummy feature is a non-match latent variable integrated in the neural net architecture of the present example that represents a latent variable that allows the GNN to assign non-matches. The dummy variable is a trainable parameter that indicates when an object is not appearing in the second scene. Any object mapped to the dummy feature indicates that there is no likely correspondence identified in the target image. A traditional method for determining a non-match may attempt use a threshold of correspondence wherein a non-match is determined if the object does not look similar enough to any objects in the target image. However, the dummy variable explicitly allows the GNN to learn a parameter that can be matched to indicate that there is a non-match in the scene (i.e., the object has disappeared), rather than deciding that an object does not exist in a scene based on a final output score that is too low.

Thus, in the step 820, the neural net architecture assigns non-matches with the GNN using the latent variable model (i.e., the dummy variable). The neural net architecture discussed in reference to FIG. 8 uses customized training augmentations for tracking tasks, in some implementations. Customized training augmentations may include erosion/dilation, mask splits, mask dropouts, and the like. In some embodiments, the neural net is trained using a customized training set created in simulation that is appropriate for simulation to real-world transfer. Training is conducted end-to-end of the tracking process, such as tracking process 800, utilizing only the object mask output from a segmentation model, allowing for quick and independent training due to the fact that there is no interdependency between the tracking model and latent features of the segmentation model.

A neural network for item correspondence predictions, in some examples, may be trained on simulated data wherein virtual objects with known sizes and locations are tracked. The present technology does not require prior knowledge about tracked objects, such as from inventory data or a database.

The technology described herein should not be limited to robotic picking applications. The present technology has many applications in which a means for object tracking related to the outputs of neural networks is useful.

The processes described herein may be implemented in several different variations of media including software, hardware, firmware, and variations or combinations thereof. For example, methods of object correspondence and tracking described herein may be implemented in software, while a computing vision system or robotic picking device may be implemented entirely in hardware or a combination. Similarly, embodiments of the technology may be implemented with a trained neural net entirely in software on an external computing system or may be implemented as a combination of the two across one or more devices. The computer vision systems and tracking model herein may be implemented on various types of components including entirely software-based implementations, entirely hardware-based aspects, such as trained computer vision systems, or variations and combinations thereof.

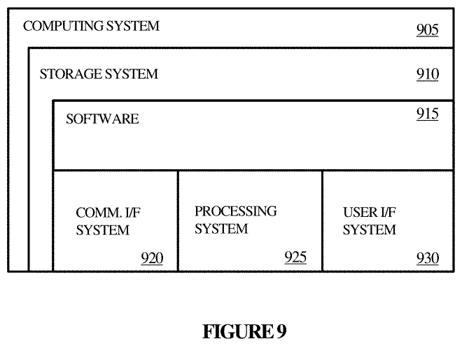

FIG. 9 illustrates computing system 905 that is representative of any system or collection of systems in which the various processes, programs, services, and scenarios disclosed herein may be implemented. Examples of computing system 905 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 905 may be implemented as a single apparatus, system, or device or may be implemented in a distributed manner as multiple apparatuses, systems, or devices. Computing system 905 may include, but is not limited to, storage system 910, software 915, communication interface system 920, processing system 925, and user interface system 930. Components of computing system 905 may be optional or excluded in certain implementations. Processing system 925 is operatively coupled with storage system 910, communication interface system 920, and user interface system 930, in the present example.

Processing system 925 loads and executes software 915 from storage system 910. Software 915 includes and implements various tracking processes described herein, which is representative of the methods discussed with respect to the preceding Figures. When executed by processing system 925, software 915 directs processing system 925 to operate for purposes of object tracking as described herein for at least the various processes, operational scenarios, and sequences discussed in the foregoing implementations. Computing system 905 may optionally include additional devices, features, or functionality not discussed for purposes of brevity.

Referring still to FIG. 9, processing system 925 may comprise a micro-processor and other circuitry that retrieves and executes software 915 from storage system 910. Processing system 925 may be implemented within a single processing device but may also be distributed across multiple processing devices or sub-systems that cooperate in executing program instructions. Examples of processing system 925 include general purpose central processing units, graphical processing units, application specific processors, and logic devices, as well as any other type of processing device, combinations, or variations thereof.

Storage system 910 may comprise any computer readable storage media readable by processing system 925 and capable of storing software 915. Storage system 910 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 910 may also include computer readable communication media over which at least some of software 915 may be communicated internally or externally. Storage system 910 may be implemented as a single storage device but may also be implemented across multiple storage devices or sub-systems co-located or distributed relative to each other. Storage system 910 may comprise additional elements, such as a controller, capable of communicating with processing system 925 or possibly other systems.

Software 915 may be implemented in program instructions and among other functions may, when executed by processing system 925, direct processing system 925 to operate as described with respect to the various operational scenarios, sequences, and processes illustrated herein. For example, software 915 may include program instructions for implementing object correspondence processes, computer vision processes, neural networks, decision making processes, or any other reasoning or operational processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 915 may include additional processes, programs, or components, such as operating system software, modeling, robotic control software, computer vision software, virtualization software, or other application software. Software 915 may also comprise firmware or some other form of machine-readable processing instructions executable by processing system 925.

In general, software 915 may, when loaded into processing system 925 and executed, transform a suitable apparatus, system, or device (of which computing system 905 is representative) overall from a general-purpose computing system into a special-purpose computing system customized for one or more of the various operations or processes described herein. Indeed, encoding software 915 on storage system 910 may transform the physical structure of storage system 910. The specific transformation of the physical structure may depend on various factors in different implementations of this description. Examples of such factors may include, but are not limited to, the technology used to implement the storage media of storage system 910 and whether the computer-storage media are characterized as primary or secondary storage, as well as other factors.

For example, if the computer readable storage media are implemented as semiconductor-based memory, software 915 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 920 may include communication connections and devices that allow for communication with other computing systems (not shown) over communication networks or connections (not shown). Examples of connections and devices that together allow for inter-system communication may include network interface cards, antennas, power amplifiers, radio-frequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 905 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of corresponding objects across scenes for robotic picking, the method comprising:
capturing one or more first images of a first scene, wherein the first scene corresponds to a first location;
identifying a distinct object in the first scene based on the one or more first images;
capturing one or more second images of a second scene, wherein the second scene corresponds to a second location; and
determining if the distinct object is in the second scene based on the one or more second images of the second scene.

2. The method of claim 1, further comprising, if the distinct object is in the second scene, identifying a correspondence between the one or more first images and the one or more second images.

3. The method of claim 1, further comprising, if the distinct object is not in the second scene, identifying a non-match between the one or more first images and the one or more second images.

4. The method of claim 1, further comprising:
capturing one or more second images of the first scene; and
determining if the distinct object is still in the first scene based on the one or more second images of the first scene.

5. The method of claim 1, further comprising directing a robotic device to move the distinct object from the first location to the second location.

6. The method of claim 5, wherein the first location is inside of a bin comprising a plurality of distinct objects and the second location is inside of a second bin.

7. The method of claim 5, wherein the robotic device comprises at least one picking element and wherein the method further comprises attempting to pick up the distinct object using the at least one picking element.

8. A system comprising:
one or more computer-readable storage media;
a processing system operatively coupled to the one or more computer-readable storage media; and
program instructions, stored on the one or more computer-readable storage media, wherein the program instructions, when read and executed by the processing system, direct the processing system to:
capture one or more first images of a first scene, wherein the first scene corresponds to a first location;
identify a distinct object in the first scene based on the one or more first images;
capture one or more second images of a second scene, wherein the second scene corresponds to a second location; and
determine if the distinct object is in the second scene based on the one or more second images of the second scene.

9. The system of claim 8, wherein the program instructions, when read and executed by the processing system, further direct the processing system to, if the distinct object is in the second scene, identify a correspondence between the one or more first images and the one or more second images.

10. The system of claim 8, wherein the program instructions, when read and executed by the processing system, further direct the processing system to, if the distinct object is not in the second scene, identify a non-match between the one or more first images and the one or more second images.

11. The system of claim 8, wherein the program instructions, when read and executed by the processing system, further direct the processing system to:
capture one or more second images of the first scene; and
determine if the distinct object is still in the first scene based on the one or more second images of the first scene.

12. The system of claim 8, wherein the program instructions, when read and executed by the processing system, further direct the processing system to direct a robotic device to move the distinct object from the first location to the second location.

13. The system of claim 12, wherein the first location is inside of a bin comprising a plurality of distinct objects and the second location is inside of a second bin.

14. The system of claim 12, wherein the robotic device comprises at least one picking element and wherein the program instructions, when read and executed by the processing system, further direct the processing system to attempt to pick up the distinct object using the at least one picking element.

15. One or more computer-readable storage media having program instructions stored thereon for identifying scene correspondences, wherein the program instructions, when read and executed by a processing system, direct the processing system to at least:
capture one or more first images of a first scene, wherein the first scene corresponds to a first location;
identify a distinct object in the first scene based on the one or more first images;
capture one or more second images of a second scene, wherein the second scene corresponds to a second location; and
determine if the distinct object is in the second scene based on the one or more second images of the second scene.

16. The one or more computer-readable storage media of claim 15, wherein the program instructions, when read and executed by the processing system, further direct the processing system to, if the distinct object is in the second scene, identify a correspondence between the one or more first images and the one or more second images.

17. The one or more computer-readable storage media of claim 15, wherein the program instructions, when read and executed by the processing system, further direct the processing system to, if the distinct object is not in the second scene, identify a non-match between the one or more first images and the one or more second images.

18. The one or more computer-readable storage media of claim 15, wherein the program instructions, when read and executed by the processing system, further direct the processing system to:
capture one or more second images of the first scene; and
determine if the distinct object is still in the first scene based on the one or more second images of the first scene.

19. The one or more computer-readable storage media of claim 15, wherein the program instructions, when read and executed by the processing system, further direct the processing system to direct a robotic device to move the distinct object from the first location to the second location.

20. The one or more computer-readable storage media of claim 19, wherein the first location is inside of a bin comprising a plurality of distinct objects and the second location is inside of a second bin.
